(19) United States
(12) Patent Application Publication
(10) Pub. No.: US 2021/0312576 A1
(43) Pub. Date: Oct. 7, 2021

(54) SYSTEM FOR AUTHENTICATING PATRON COMPUTING DEVICE AND ALLOWING ORDERING FOOD THEREFROM AT RESTAURANT

(71) Applicant: tblside technologies inc., Calgary (CA)

(72) Inventor: Ty William Dennis Clarke, Calgary (CA)

(21) Appl. No.: 17/209,424

(22) Filed: Mar. 23, 2021

Related U.S. Application Data
(60) Provisional application No. 63/004,270, filed on Apr. 2, 2020.

(51) Int. Cl. G06Q 50/12; G06Q 30/06; G06Q 20/14; G06Q 20/32

(52) U.S. Cl. CPC G06Q 50/12; G06Q 30/0635; G06K 19/06037; G06Q 20/3274; G06Q 20/14

(57) ABSTRACT

A system for ordering and purchasing food utilizing a patron device at a restaurant includes a staff device and an order server. The order server creates an order and a code identifying the order. The code is sent to the staff device where it is displayed. The patron device scans and sends the code to the order server, which determines whether the received code matches a still-active order. When yes, the order server stores an association of the patron device with the order and adds to the order food items specified messages received from the patron device. The patron device may thereafter be trusted and utilized to add subsequent patron devices to the order in a similar manner without involvement of the staff device. The order server tracks food items ordered and presents a billing screen on each device with only items ordered on each device preselected for payment.

### CROSS-REFERENCE TO RELATED APPLICATIONS

This application claims the benefit of priority of U.S. Provisional Application No. 63/004,270 filed Apr. 2, 2020, which is incorporated herein by reference.

### BACKGROUND OF THE INVENTION

### (1) Field of the Invention

The invention pertains generally to computerized food ordering systems utilized at restaurants. More specifically, the invention relates to systems, methods, and apparatuses for authenticating one or more patron computing devices at a restaurant and allowing food to be ordered utilizing those devices.

### (2) Description of the Related Art

Restaurants are interested in leveraging high tech devices to improve their guest experiences. For instance, instead of (or in addition to) printed menus, many restaurants utilize tablet devices such as iPads® to allow patrons to view available food items and possibly make orders directly from the device. In simple implementations, the tablet device merely replaces the paper menu and ordering is done via server staff in the usual manner; however, more sophisticated systems allow patrons to electronically order directly from the tablet device.

There are several problems with restaurants providing their patrons with tablet or other computing devices for ordering purposes.

For one, cost is a major problem. The restaurant needs to make a high initial investment to purchase sufficient devices to cover all tables that may be simultaneously ordering. In some cases, multiple people at a single table may also desire to have their own menu and multiple devices per table will thus need to be available. Ten to twenty thousand dollars in hardware investment could be required to purchase approximately twenty or so tablets. Depending on the size of the restaurant, the initial investment could be even higher. The costs do not end with the initial investment—maintenance, breakage and theft of the devices all increase the overall cost for a restaurant utilizing such a system.

Another problem is cleanliness. Unlike paper menus which can be reprinted, often at low incremental cost, electronic devices must be reused for years to recoup their initial investment. Thus, the electronic devices get dirty over time and proper sanitization of the devices is required to avoid passing germs between parties. However, sanitizing electronic devices may be low on the priority list of busy waitstaff and may not be done as well as it should. Health and wellness of patrons may therefore be impacted by sharing improperly-cleaned tablet devices immediately prior to eating.

To avoid the above problems, there have been attempts by restaurants to allow patrons to utilize patron-owned electronic devices to order food instead of utilizing restaurant-provided devices. However, the logistical and technical problems are many. Complicated sign up processes, account creation and verification, installation of different custom software applications (apps) for each individual restaurant, security concerns, fraud prevention, and the various resulting losses of privacy have all worked to prevent adoption.

Typical restaurant patrons are hungry and have no time or desire to follow complicated technical procedures prior to being able to order food. There is thus need in the industry for an easy-to-use and secure system allowing patrons at a restaurant to quickly browse and order food items on their own mobile devices.

### BRIEF SUMMARY OF THE INVENTION

According to an exemplary embodiment of the invention there is disclosed a system for ordering and purchasing food utilizing a patron computing device at a restaurant. The system includes a staff computing device coupled to a computer network and an order server coupled to the computer network. By executing a plurality of software instructions loaded from one or more storage devices, the order server is configured to create an order and store a code for uniquely identifying the order in the one or more storage devices. The order server is further configured to send the code to a first device via the computer network to thereby cause the first device to display the code on a display of the first device and allow a second device to scan the code. The first device is one of the staff computing device and the patron computing device, and the second device is another of the staff computing device and the patron computing device, the second device being different than the first device. The order server is further configured to receive a received code from the second device via the computer network and determine whether the received code matches the code uniquely identifying the order. In response to determining that the received code matches the code, the order server is further configured to send a confirmation request to the first device to thereby query a user of the first device whether they authorize adding the patron computing device to the order. The order server is further configured to receive a confirmation response from the first device via the computer network, and, in response to the confirmation response authorizing adding the patron computing device to the order, store an association of the patron computing device with the order in the one or more storage devices and add to the order one or more food items as specified in one or more messages received from the patron computing device via the computer network.

According to an exemplary embodiment of the invention there is disclosed a system for ordering and purchasing food utilizing a patron device at a restaurant. The system includes a staff device and an order server. The order server creates an order and a code identifying the order. The code is sent to the staff device where it is displayed. The patron device scans and sends the code to the order server, which determines whether the received code matches a still-active order. When yes, the order server stores an association of the patron device with the order and adds to the order food items specified messages received from the patron device. The patron device may thereafter be trusted and utilized to add subsequent patron devices to the order in a similar manner without involvement of the staff device. The order server tracks food items ordered and presents a billing screen on each device with only items ordered on each device preselected for payment.

According to an exemplary embodiment of the invention there is disclosed a system for ordering and purchasing food utilizing a plurality of patron computing devices at a restaurant. The system includes a staff computing device coupled to a computer network, and an order server coupled to the computer network. By executing a plurality of software instructions loaded from one or more storage devices, the order server is configured to create an order and store a code for uniquely identifying the order in the one or more storage devices. The order server is further configured to send the code to a first device via the computer network to thereby cause the first device to display the code on a display of the first device and allow a second device to scan the code, wherein the first device is one of the staff computing device and a first patron computing device, and the second device is another of the staff computing device and the first patron computing device, the second device being different than the first device. The order server is further configured to receive a received code from the second device via the computer network and determine whether the received code matches the code uniquely identifying the order. The order server is further configured to, in response to determining that the received code matches the code, store an association of the first patron computing device with the order in the one or more storage devices and add to the order one or more first food items as specified in one or more messages received from the first patron computing device via the computer network. The order server is further configured to receive a second received code from a second patron device via the computer network, wherein the second patron device determined the second received code as a result of interacting with the first patron computing device. The order server is further configured to determine whether the second received code matches the code uniquely identifying the order. The order server is further configured to, in response to determining that the second received code matches the code, store an association of the second patron computing device with the order in the one or more storage devices and add to the order one or more second food items as specified in one or more messages received from the second patron computing device via the computer network. In this way, both the first patron computing device and the second patron computing device add one or more food items to the order.

According to an exemplary embodiment of the invention there is disclosed a system for ordering and purchasing food utilizing a plurality of patron computing devices at a restaurant. The system includes a staff computing device coupled to a computer network and an order server coupled to the computer network. By executing a plurality of software instructions loaded from one or more storage devices, the order server is configured to create an order and store a code for uniquely identifying the order in the one or more storage devices and send the code to a first device via the computer network to thereby cause the first device to display the code on a display of the first device and allow a second device to scan the code. The first device is one of the staff computing device and a first patron computing device, and the second device is another of the staff computing device and the first patron computing device, the second device being different than the first device. The order server is further configured to receive a received code from the second device via the computer network and determine whether the received code matches the code uniquely identifying the order. In response to determining that the received code matches the code, the order server is configured to store an association of the first patron computing device with the order in the one or more storage devices and add to the order one or more first food items as specified in one or more messages received from the first patron computing device via the computer network.

Exemplary advantages of some embodiments include smoother patron/waiter interactions—i.e., dine at your own pace. Restaurant efficiency is increased and therefore increases table turnover, patron experience, and overall revenue. Restaurant owners save money by shifting roles of staff (e.g. waiter turns into runner) and therefore reduces the amount of people needed to run the restaurant.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 shows a block diagram of a system for ordering food utilizing a patron computing device at a restaurant according to an exemplary embodiment.

FIG. 2 shows a block diagram of the order server of FIG. 1 being a computer server and having one or more processors coupled to one or more storage device(s) and communications interface(s).

FIG. 3 shows a flowchart of a method of authenticating a patron computing device and allowing ordering food therefrom at restaurant according to an exemplary embodiment.

FIG. 4 illustrates a UI screen for initiating a new order according to an exemplary embodiment.

FIG. 5 illustrates a UI screen for display the order code along with a link for scanning by another device according to an exemplary embodiment.

FIG. 6 illustrates a UI screen for confirming adding a new patron device to an order according to an exemplary embodiment.

FIG. 7 illustrates a data association diagram illustrating an example of three patron devices being associated with a single order according to an exemplary embodiment.

FIG. 8 shows a data association diagram illustrating a fourth patron device being associated with the order according to an exemplary embodiment.

FIG. 9 illustrates a UI screen for welcoming a user of a new patron device to the restaurant after the new patron device is confirmed to be added to an order according to an exemplary embodiment.

FIG. 10 illustrates a UI screen for adding a food item such as a burger to the order according to an exemplary embodiment.

FIG. 11 illustrates a UI screen for previewing an open order prior to submission according to an exemplary embodiment.

FIG. 12 illustrates a UI screen allowing users to check the items that have been ordered and that are on their way according to an exemplary embodiment.

FIG. 13 illustrates a UI screen showing a pop-up alert that appears when the user presses one of the “Pay now” buttons according to an exemplary embodiment.

FIG. 14 illustrates a UI screen illustrating an order summary displayed after the order is concluded according to an exemplary embodiment.

FIG. 15 illustrates a UI screen allowing a patron device to add another patron device to the order in a daisy chain manner according to an exemplary embodiment.

FIG. 16 illustrates an example of a trusted patron device displaying a QR code associated with an order in order to add a new patron device to the order according to an exemplary embodiment.

FIG. 17 shows a data association diagram illustrating the new patron device has been added to the order after scanning the QR code by the trusted patron device in FIG. 16.

FIG. 18 shows an authentication process for adding a new patron device to an order where the unique code for identifying the order is displayed on either a trusted or untrusted device according to an exemplary embodiment.

FIG. 19 shows a pay now screen for a first mobile device where all food items of the restaurant table are shown and available for payment, but only the food items actually ordered utilizing the first mobile device are preselected for payment.

FIG. 20 shows a pay now screen for a second mobile device where all food items of the restaurant table are shown and available for payment, but only the food items actually ordered utilizing the second mobile device are preselected for payment.

### DETAILED DESCRIPTION

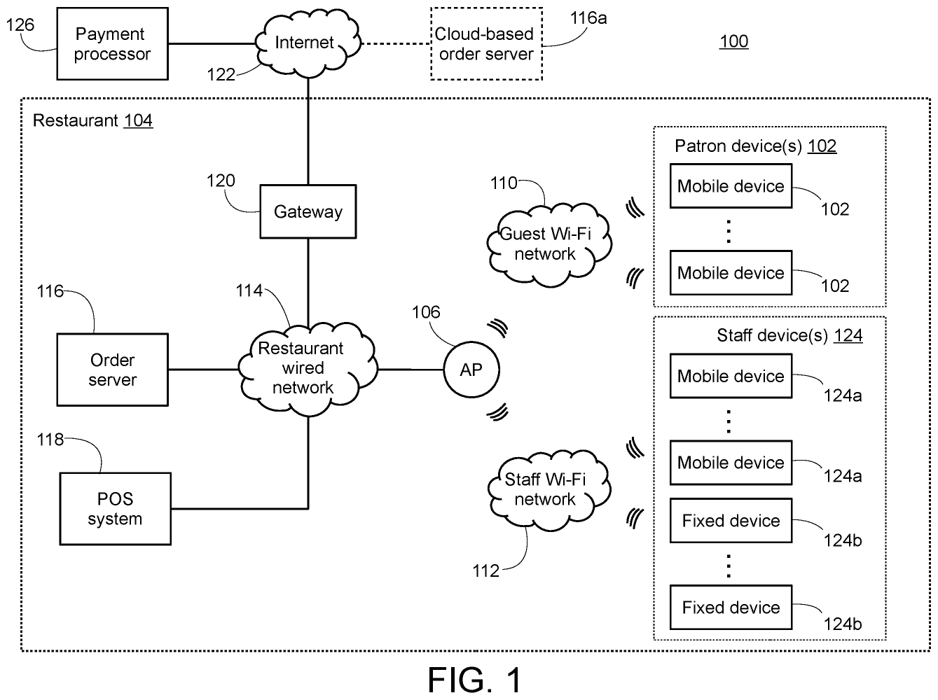

FIG. 1 shows a block diagram of a system 100 for ordering food utilizing a patron computing device 102 at a restaurant 104 according to an exemplary embodiment. In this embodiment, the restaurant 104 provides a wireless access point (AP) 106 providing two wireless networks: a guest Wi-Fi network 108 and a staff Wi-Fi network 110. The two wireless networks 110, 112 may be provided by the AP 106 utilizing a different service set identifier (SSID) and/or virtual local area network (VLAN) for each. The AP 106 is coupled to a wired network 114 at the restaurant 104, and an order server 116 and a point of sale system 118 are coupled to the wired network 114. A gateway 120 is coupled to the wired network 114 and provides access to the Internet 122.

The computing devices 102, 124 that utilize the wireless networks 110, 112 available at the restaurant 104 include the patron computing devices 102 and staff computing devices 124. The patron devices 102 are devices such as mobile phones, laptop and netbook computers, and tablet devices carried to the restaurant 104 by patrons. The staff devices 124 include mobile devices 124a carried by staff members during their job as well as fixed devices 124b such as restaurant tabletop devices and kiosks that may be located at various positions around the restaurant 104.

In the embodiment shown in FIG. 1, the order server 116 is located on premise at the restaurant along with the POS system 118. In this way, even if the Internet 122 should go down, these devices remain available and the restaurant 104 can keep functioning as normal. However, as will be explained further below, it is also possible in other embodiments to have a cloud-based order server 116a be coupled to the restaurant 104 via the Internet 122. In some embodiments, only one of the local order server 116 and the cloud-based order server 116a is utilized. A payment processor 126 may also be coupled to the restaurant 104 via the Internet 122.

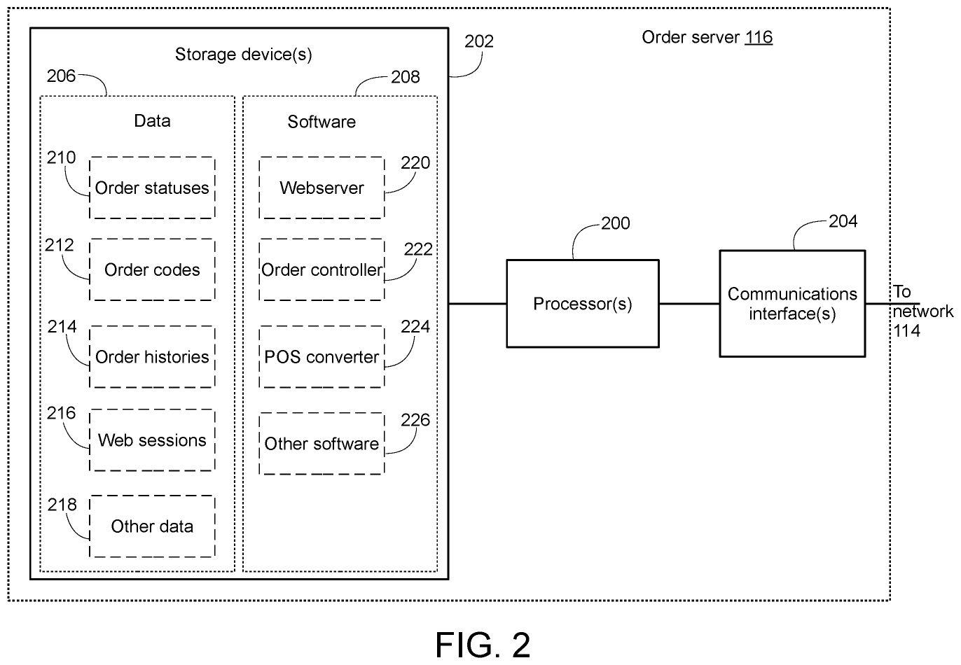

FIG. 2 shows a block diagram of the order server 116 being a computer server and having one or more processors 200 coupled to one or more storage device(s) 202 and communications interface(s) 204. In this embodiment, the storage devices 202 include data 206 and software 208 utilized by the processors 200 to perform the various functions of the order server 116 shown and described below. The data 206 in this embodiment is organized as a number of tables in a database such as a relational database; however, any desired structured organization of data may be utilized in other embodiments. The processors 200 execute instructions of the software 208 loaded from the one or more storage devices 202 in order to create and make use of the data 206.

To avoid confusion, the term “database table” is utilized herein when referring to tabular tables of information as stored in data 206, whereas the term “restaurant table” is utilized when referring to the physical tables at a restaurant 104.

The data 206 in this embodiment includes order statuses 210, order codes 212, order histories 214, and web sessions 216. Any other data 218 may also be stored as needed. The software 208 in this embodiment includes a webserver 220, an order controller 222, and a POS converter 224. Likewise, any other software 226 may also be stored as needed.

The one or more processors 200 may be included in a central processor unit (CPU) of the computer server acting as the order server 116. In the following description the plural form of the word “processors” will be utilized as it is common for a CPU of a computer server to have multiple processors 200 (sometimes also referred to as cores); however, it is to be understood that a single processor 200 may also be configured to perform the described functionality in other implementations.

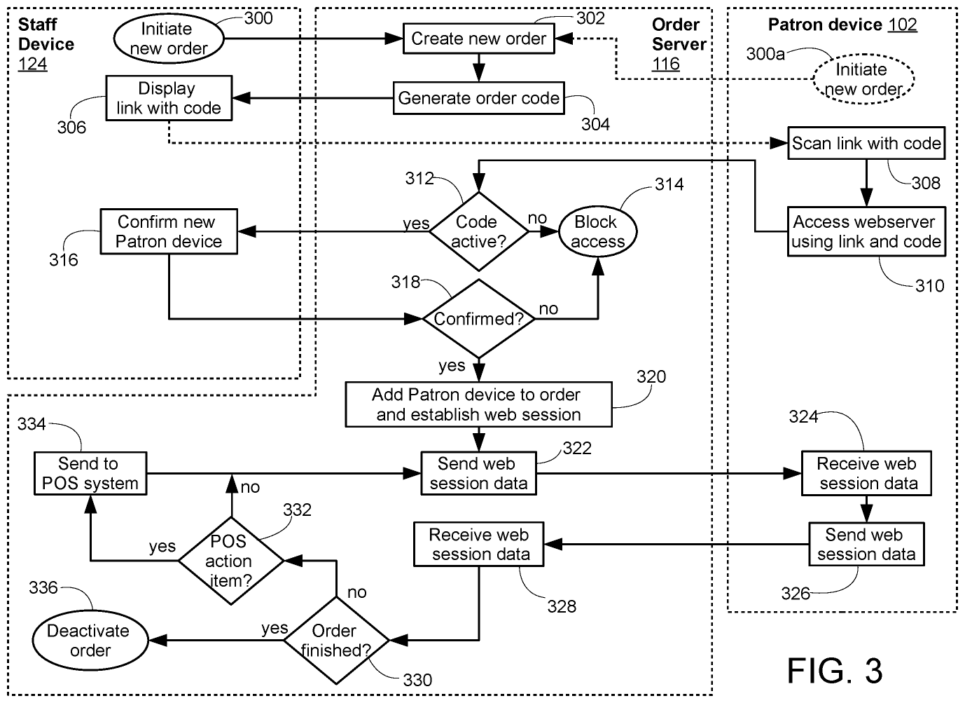

FIG. 3 shows a flowchart of a method of authenticating a patron computing device 102 and allowing ordering food therefrom at restaurant 104 according to an exemplary embodiment. The steps of FIG. 3 indicated as being performed by the staff device 124 may be performed by one or more processors of the staff device executing software such as a web browser or other application loaded from a storage device of the staff device 124. The steps of FIG. 3 indicated as being performed by the order server 116 may be performed by processors 200 of the order server 116 executing software including the order controller 222, webserver 220, and POS converter 224 loaded from the storage device 202. The steps of FIG. 3 indicated as being performed by the patron device 102 may be performed by one or more processors of the patron device 102 executing software such as a web browser or other application loaded from a storage device of the patron device 102. The steps of the flowchart are not restricted to the exact order shown, and, in other configurations, shown steps may be omitted or other intermediate steps added.

The process begins at step 300 when the staff device 124 is utilized to initiate a new order. The order in this embodiment represents the food items ordered by a party at the restaurant 104. The order may be billed on a single bill or may alternatively be separated into different bills; however, as a group, the order is associated with a single party which may be seated at a common restaurant table.

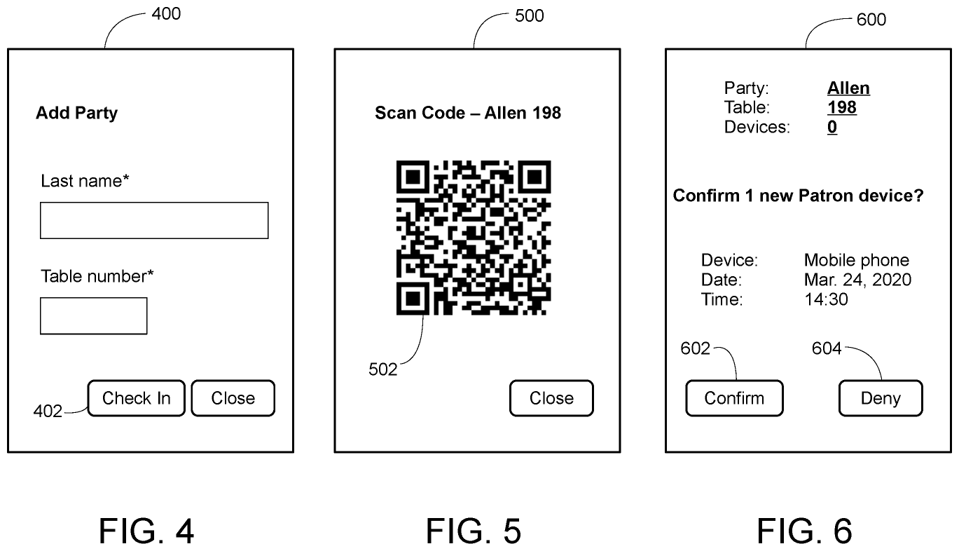

In some embodiments, step 300 involves host staff at the restaurant 104 entering a restaurant table number and possibly other patron information such as a first or last name of the patron into a user interface of the staff device 124, as shown in FIG. 4. A new order initialization message is sent by the staff device 124 to the order server 116. For instance, the staff device 124 may already be logged in and connected to the order server 116 and the check-in screen 400 (FIG. 4) may be a web page provided by the web server 220. The staff device 124 is therefore preprogrammed to post the new order initialization message to the address of the webserver 220 via the staff wireless network 112.

At step 302, the order server 116 receives the new order initialization message and creates a new order record in the storage device 202. This may involve the order server 116 creating a new “active” order in the order statuses 210. An identifier for the order in some embodiments is the restaurant table number associated with the party at the restaurant 104, and the restaurant table number may be either entered manually by the host staff when seating the party initially or automatically selected by the order server 116 to be any available restaurant table, for example.

At step 304, the order server 116 generates an order code for uniquely identifying the order. The order code may be a hash value generated by the order server 116 applying a hashing function on a combination of inputs including, in some embodiments, at least the date and time that the order is generated. In some embodiments, the order code is an encrypted value generated by the order server 116 applying an encryption function on a combination of inputs including, in some embodiments, at least the date and time that the order is generated. Other inputs that may be utilized for the encryption function include the order identifier (e.g., restaurant table number) and patron information such as first and/or last name. The order server 116 may further cryptographically sign the order code in order to further decrease the likelihood of a hacker brute forcing the code value.

The order code is temporally unique such that, over a predetermined time period, there is only one active order associated with the order code. In preferred embodiments, the order server 116 changes the code generated for each new order and makes sure it is not the same as a last order code utilized over a period of time. For instance, in some embodiments, the order server 116 ensures that order codes are unique over a predetermined time period of one year.

In some embodiments, the order server 116 further generates a QR code that encodes the order code within a uniform resource locator (URL) including an address where the webserver 220 is reachable on the guest Wi-Fi network 110 at the restaurant 104. For instance, assuming the webserver 220 provided by the order server 116 is available at an address of restaurant.example.com, the QR code may encode the following information:

https://restaurant.example.com/login?code=4ac00583690d552d7

where the webserver 220 provided by the order server 116 has a secure socket layer (SSL) certificate verified to provide hypertext transfer protocol secure (HTTPS) connections at the domain of “restaurant.example.com”, the login page for creating new orders is located at “/login” and the order code is passed via the URL as a “code” parameter with an exemplary encrypted string value being “4ac00583690d552d7”. In this example, the order statuses database table 210 may include the following information:

Example database table data: Order statuses 210

| Order ID (e.g., restaurant table number) | Patron name | Order status |
|---|---|---|
| “198” | Allen | Active |

Likewise, depending on the type of order code, the order codes database table 212 may also be updated to store the order code generated at step 304. When utilizing a 2-way (reversable) encryption function, it is not necessary to store the order code in the database because, upon later receipt of the code (e.g., at step 312), the order server 116 can simply decrypt the code in order to obtain the information regarding the order, such as the order ID and patron name. However, when the order code is generated at step 304 utilizing a 1-way (non-reversable) hashing function, the order codes database table 212 may be updated at step 304 to store the generated order code and thereby allow the server 116 to later determine with which order ID a received code is associated. For example, assuming a 1-way hashing function is utilized to generate the order code, the order codes database table 212 may by updated by the server 116 to include the following information:

Example database table data: Order codes 212

| Order ID (e.g., restaurant table number) | Order code |
|---|---|
| “198” | 4ac00583690d552d7 |

At step 304, the order server 116 in this embodiment sends back to the staff device 124 an image file (e.g., a PNG image file) of the generated QR code with the order code embedded as a passed parameter on the URL encoded into the QR code.

At step 306, the staff device 124 receives the order code and displays a link along with the code on a display device of the staff device 124. For instance, assuming the order code is encoded in a QR code along with a URL associated with a particular web page provided by the order server 116 as described above for step 304, the staff device 124 may display the link and code by displaying a QR code image screen 500, such as shown in FIG. 5.

At step 308, the patron of the restaurant 104 uses any software application that has the capability to read a graphical code to scan the QR code. For instance, the patron may utilize the camera app or web browser app on their patron device 102 (e.g., their mobile phone) to thereby trigger the patron device 102 to scan the QR code displayed on the staff device 124. Most recent smartphones have built-in software to decode QR codes, for instance, taking a picture of or otherwise scanning the QR code utilizing the camera app may provide a clickable link based on the URL information encoded in the QR code to be displayed to the user. The user may click the link in order to open the URL in a web browser running on the patron device 102. Alternatively, the web browser itself may include software that automatically scans QR codes utilizing the device's camera and then opens the URL as specified in the QR code.

At step 310, the patron device 102 accesses the web server 220 provided by the order server 116 according to the URL encoded in the QR code. Because the order code in this embodiment is a parameter passed via the URL, accessing the webserver 220 at step 310 causes the order code to be passed from the patron device 102 back to the webserver 220.

At step 312, the order controller 222 running on the order server 116 compares the received code received from the patron device 102 at step 310 with the original code for identifying the order as generated by the order server 116 at step 304. In some embodiments, step 312 involves the order server 116 searching the order codes 212 in order to determine whether any order identifier is associated with the received code, and, when yes, then searching the order statuses 210 in order to determine whether the matching order identifier is still listed as being of “active” status. When the received code does not correspond to any active order, control proceeds to step 314 to block access. Alternatively, in the event the received code does correspond to an active order, the order server 116 sends a confirmation request message to the staff device 124 and control proceeds to step 316.

At step 314, the order server 116 blocks access to the patron device 102. In general, when reaching this step 314, the order server 116 does not add the patron device 102 to the order and the patron device 102 is therefore not able to order food items since the patron device 102 is not associated with any active order. Step 314 may be reached, for example, if a user takes a picture of a QR code and then several weeks later tries to scan it from home. Assuming the order associated with the code has a status such as “complete” or any other status that is not “active”, the check at step 312 will fail and the “no” branch will be followed to step 314.

Another way step 314 can be reached is if the staff device 124 denies adding the patron device 102 to the order—i.e., “no” branch from step 318. This may be the case if an unauthorized person at the restaurant 104 utilizes their phone to take a picture of the valid QR code, for instance, over the shoulder of the authorized party for whom the QR code was intended to be scanned. In this case, the staff member can deny the unauthorized patron device 102 from being added to the order.

Although not illustrated at step 314, other steps may also be provided here such as establishing a web session with the patron device 102 and sending back error messages or other information. For instance, even though the patron device 102 is not added to the order and cannot be utilized to order food, it may be desirable to still allow the patron device 102 to browse the menu, for example.

At step 316, the staff device 124 displays a new device confirmation screen allowing a user of the staff device 124 to either confirm or deny adding the patron device 102 to the order. An example of a new confirmation device screen 600 is shown in FIG. 6. A confirmation response message is sent from the staff device 124 back to the order server 116 and includes information about which button was pressed by the user—either “Confirm” or “Deny” in this embodiment.

At step 318, the order server 116 determines whether the confirmation response received from the staff device 124 authorizes adding the patron device 102 to the order. When no, control proceeds to step 314 to block access; alternatively, when authorization is granted, control proceeds to step 320.

At step 320, the order controller 222 adds the patron device 102 to the order and the webserver 220 running on the order server 116 establishes a web session with the patron device 102. The web session may be established in response to the access request message sent by the patron device 102 at step 310 or may be in response to any other webpage request sent by the patron device 102. For instance, in some embodiments, while waiting for the staff member to confirm authorization for the patron device 102 at step 316, the order server 116 may still allow the patron device 102 to browse the restaurant menu and begin marking food items. These marked food items are automatically added to the order by the order server 116 after the patron device 102 is added to the order at step 320.

In this embodiment, the order controller 222 adds the patron device 102 to the order by updating the web sessions database table 216 to include an association between an identifier of the web session and the active order identified by the received code confirmed at step 318. For instance, assuming the received code confirmed at step 318 is matched with order identifier “198” (i.e., the order associated with restaurant table “198”), the order controller 222 updates the web sessions database table 216 to include the following information:

Example database table data: Web sessions 216

| | Web session identifier |
|---|---|
| Order ID (e.g., restaurant table number) | (e.g., PHPSESSID) |
| “198” | h5onbf7pctbr0t68adugdp2611 |

where the web session identifier in this embodiment is the PHP (PHP: Hypertext Preprocessor) session identifier stored in a cookie on the patron device 102 and passed to the webserver 220 in all web requests from the patron device 102 during the session to allow the webserver 220 to identify the web session. Although PHP is utilized in this embodiment, any desired web scripting language and/or web session identifier may be utilized in a similar manner in other embodiments.

At step 322, the webserver 220 sends web session data to the patron device 102. For example, this data may include menu items and options for the user to order desired food items.

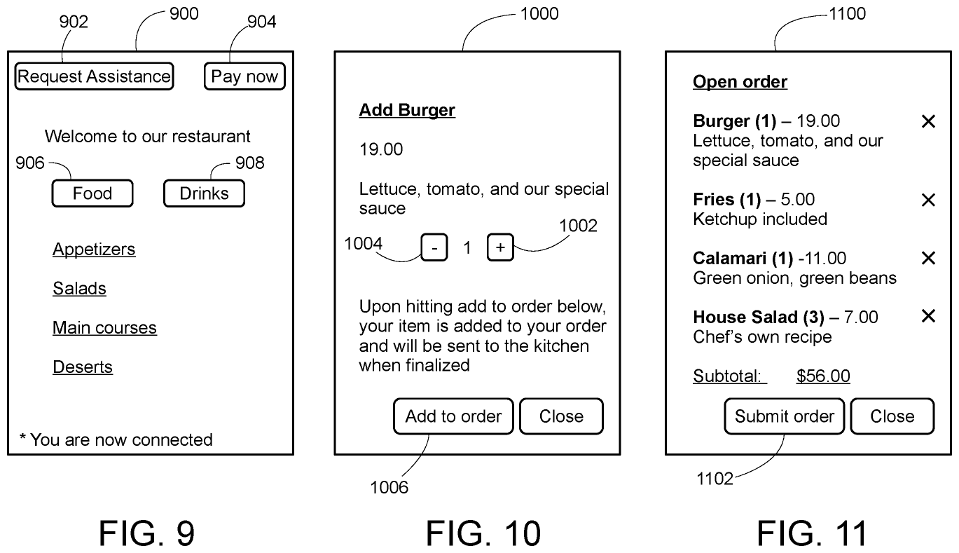

At step 324, the patron device 102 receives the web session data from the webserver 220 and displays it in a web browser for a user of the patron device 102 to see the data and interact with control elements such as buttons, sliders, dialog boxes, etc. rendered by the web browser on a display screen of the patron device 102. Examples of web session screens that may be displayed to the user are shown in FIGS. 9 to 15 and described later.

At step 326, the web browser running on the patron device 102 sends web session data back to the web server 220. This data will typically represent user actions on control elements displayed in the browser. For example, the user may order a burger and the web session data sent back at step 326 includes an indication that the burger has been selected for ordering. In another example, a user may click a “Pay Now” button or an “Add new device” button and messages representing these actions are sent from the patron device 102 back to the webserver 220.

At step 328, the webserver 220 running on the order server 116 receives the web session data from the patron device 102.

At step 330, the order controller 222 determines whether the order associated with the web session is finished. For instance, after the meal is done, the user of the patron device 102 may click a “Pay Now” button and confirm that they are ready to submit payment. Upon receiving such a message, the order is deemed to be finished and step 330 proceeds to step 336 to deactivate the order code.

However, there are other ways that the order controller 222 may find at step 330 that the order is finished. For instance, in cases where there is no finish order message contained in the web session data received at step 328, step 330 may involve the order controller 222 searching the web sessions 216 to find the order identifier and then checking the order statuses database table 210 to determine whether that order identifier is still listed as “active”. Performing this check to see if the order is still “active” before adding new food items to the order is beneficial to prevent fraud such as someone trying to order food items on an original party's bill after the original party has already paid and the order is concluded.

In cases where the order is currently being finished such as the “Pay Now” or other close order message in the web session data received at step 328, and in cases where the order was already marked to something other than “active” in the order statuses 210, the order is deemed to be finished and control proceeds to step 336.

At step 332, the order controller 222 determines whether the web session data received at step 328 includes any POS action items. For instance, the order controller 22 checks whether the web data includes an order for a particular food item. When yes, control proceeds to step 334; otherwise, control returns to step 322 to send a next screen of web session data back to the patron device 102.

At step 334, the order controller 222 utilizes the POS converter 224 to generate and send a food order message to the restaurant's POS system 118. For instance, the food order message may include an identification of one or more food items received from the patron computing device at step 328. Since different restaurants 104 may utilize different POS systems 118, the POS converter 224 beneficially converts the order message to utilize a format compatible with the target POS system 118. This step may also include the order controller 222 updating the order history 214 to include a record of the food items that have been purchased on the order. The information stored in the order histories database table 214 is beneficial to allow the webserver 220 to send order status information and subtotals to the patron device 102 at any time—see FIG. 14, for example.

At step 336, the order controller 222 deactivates the order. If it is not already done, deactivating the order at step 336 may include the order controller 222 changing the status in the order statuses database table 210 to be something other than “active”. For instance, other status identifiers may include “canceled”, “paid in full”, “pending payment”, “on hold”, etc. Although changing the status is sufficient to deactivate the order in many embodiments, deactivating the order may also include the order controller 222 removing or otherwise deactivating the association of the code with the order identifier in the order codes database table 212. Likewise, deactivating the order may also include removing the association of the web session identifier and the order identifier in the web sessions database table 216.

FIG. 4 illustrates a UI screen 400 for initiating a new order according to an exemplary embodiment. For instance, the UI screen 400 may be displayed on the staff device 124 at step 300 of the flowchart of FIG. 3. Upon seating a new party, a host staff member of the restaurant 104 enters the party's last name and restaurant table number and presses the “Check In” button 402.

FIG. 5 illustrates a UI screen 500 for displaying the order code along with a link for scanning by another device according to an exemplary embodiment. For instance, the QR code image 502 may be displayed on the staff device 124 at step 306 of the flowchart of FIG. 3. The host staff member would then show the QR code image 502 to or more members of the party so that those members can utilize their own patron devices 102 to scan the QR code (i.e., at step 308).

FIG. 6 illustrates a UI screen 600 for confirming adding a new patron device 102 to an order according to an exemplary embodiment. For instance, the confirm new device UI screen 600 may be displayed on the staff device 124 at step 316 of the flowchart of FIG. 3 after a patron device 102 has scanned the QR code 502. As illustrated, the screen 600 includes details of the order for which the patron device 102 will be added along with some details of the patron device 102 itself. Assuming the user such as the host staff wishes to authorize the patron device 102 to be added to the order, the user presses the “Confirm” button 602. If the device is unrecognized or if the device is not desired to be added to the order, the user presses the “Deny” button 604.

In the above flowchart of FIG. 3, it has so far been assumed that a single patron device 102 is added to a new order. For instance, at the time that the UI screen 600 of FIG. 6 is displayed, there are zero (0) devices associated with the order and one new device is requested to be added. However, in some embodiments, any number of different patron devices 102 may be added to a single order and the new devices can be added at any time during the order, not just at the beginning of the order.

FIG. 7 illustrates a data association diagram illustrating an example of three (3) patron devices 102 being associated with a single order 700. The order controller 222 may associate multiple patron devices 102 with a single order 700 by adding multiple rows to the web sessions database table 216—one row for each patron device 102. For instance, assuming the order identifier is restaurant table “198”, the web sessions database table may include a unique PHP session id or other web session identifier for each of patron device A, B, and C.

Example database table data: Web sessions

| | Web session identifier |
|---|---|
| Order ID (e.g., restaurant table number) | (e.g., PHPSESSID) |
| “198” | session ID for Patron device A |
| “198” | session ID for Patron device B |
| “198” | session ID for Patron device C |

Each of patron devices A, B, C may be added by scanning the link with code at step 308 of FIG. 3, for example. In other words, the host staff may display the QR code 502 (FIG. 5) when the party is seated and that QR code 502 is scanned by each of patron devices A, B, C. This will cause a separate iteration of the general process illustrated in FIG. 3 to start at step 308 for each patron devices A, B, C. In this way, all three members of the party may simultaneously utilize their own devices 102 to browse the restaurant menu and order food items, which are all associated with the single order identifier (i.e., restaurant table number) in the POS system 118. All food items ordered go onto the same order history 214 for the order 700.

Furthermore, other new patron devices 102 may easily be added to the order 700 at any later time.

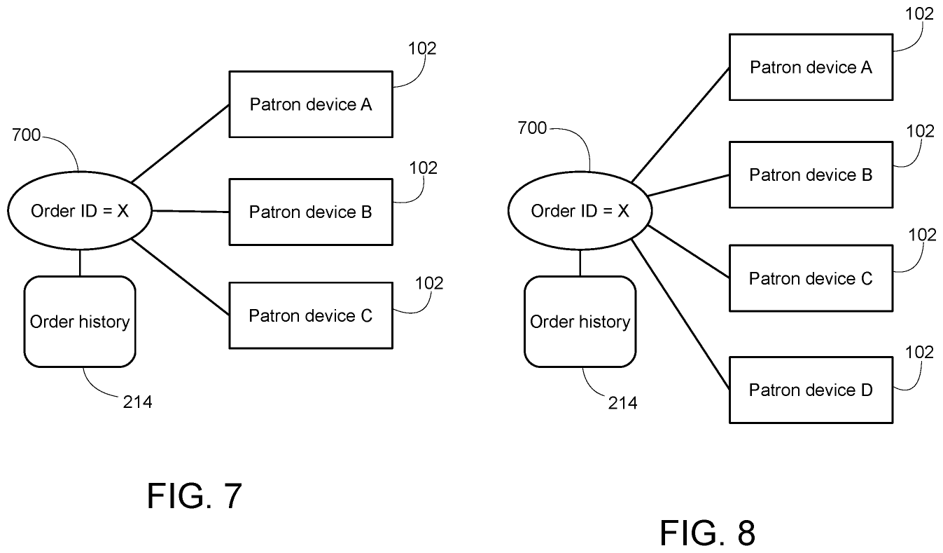

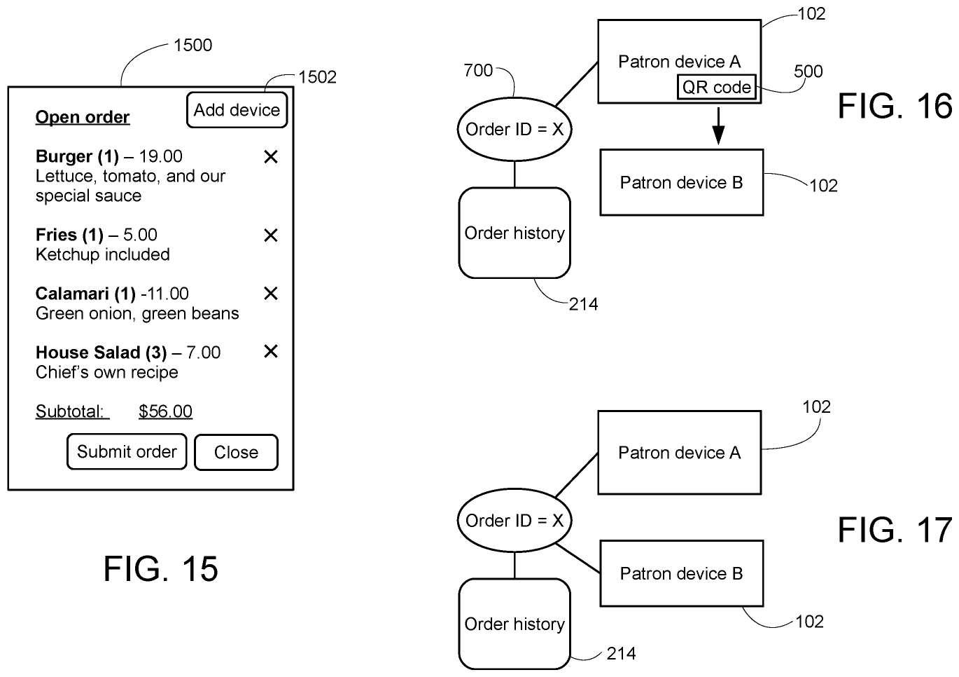

FIG. 8 shows a data association diagram illustrating a fourth patron device 102 being associated with the order 700. This may occur, for example, when another member of the party arrives late after the party has already been seated. At this point in time, the host staff or another staff at the restaurant 104 such as wait staff may utilize a staff device 124 to re-display the QR code 502 associated with the order (FIG. 5) and the new member of the party utilizes their patron device D to scan said code 502. Likewise, as explained further below, a current member of the party may also utilize one of the patron devices A, B, C already associated with the order to display the QR code 502 thereby allowing scanning by a subsequent patron device D to occur without requiring bothering restaurant 104 staff. This is referred to as daisy chaining patron device 102 logins and is explained in more detail below with reference to FIGS. 15 to 18.

FIG. 9 illustrates a UI screen 900 for welcoming a user of a new patron device 102 to the restaurant 104 after the new patron device 102 is confirmed to be added at step 318. The welcome screen 900 is sent to the patron device 102 by the webserver 220 at step 322, and, in this embodiment, the screen 900 is displayed in a web browser running on the patron device 102. The welcome screen 900 may also act as a home screen such as a top menu of the restaurant 104 for logged in users. A button 902 is provide to “Request Assistance”, which when clicked and a corresponding message is received by the webserver 220 (at step 328), will trigger an alert on one of the staff devices 124. A staff member can then read the alert and go to the restaurant table associated with the order to provide assistance. For example, perhaps the diners need a new fork because one fell on the ground.

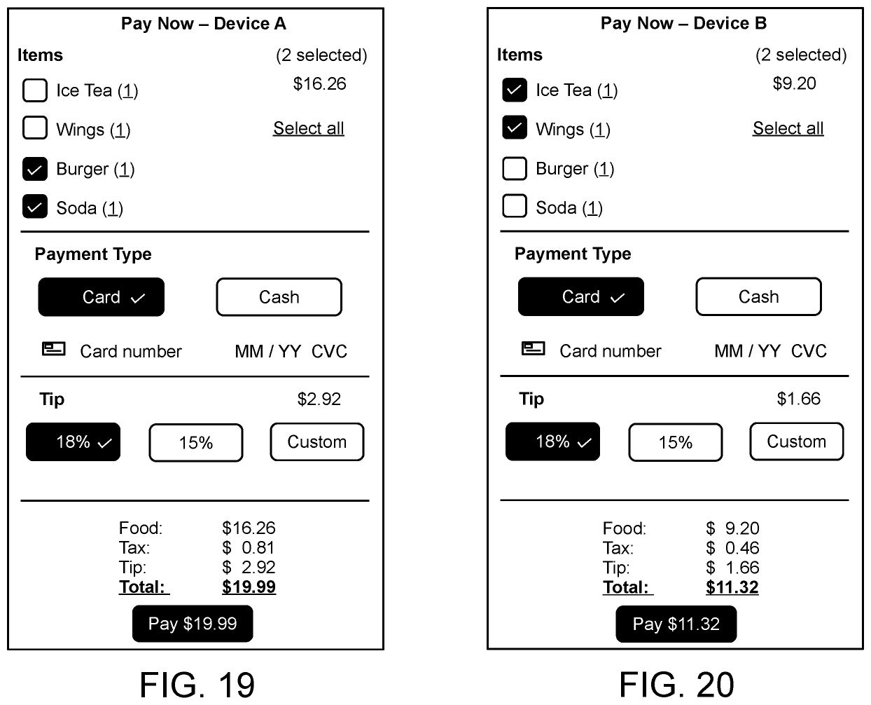

The “Pay now” button 904 initiates the payment process—see FIG. 13 for one example where waitstaff is automatically notified to bring the check to the table. See FIGS. 19 and 20 for another example where the user(s) in the party can pay utilizing an online payment process performed on the mobile device(s) 102.

The “Food” and “Drinks” buttons 906, 908 allow the user to switch between the food and drink menus. Although this example has drinks being a separate category than food, this is for presentation to the users only and behind the scenes the order server 116 and POS system 118 may generally treat all food items including both solids food items and liquid food items the same.

FIG. 10 illustrates a UI screen 1000 for adding a food item such as a burger to the order according to an exemplary embodiment. As illustrated, the user may utilize the plus and minus buttons 1002, 1004 to change the quantity. When the correct quantity is selected, the user may press the “Add to order” button 1006 to cause the item to be added to the order.

FIG. 11 illustrates a UI screen 1100 for previewing an open order prior to submission. This screen 1100 allows the user to preview and check the plurality of items that are about to be ordered. Assuming the information as listed is correct, the user can click the “Submit order” button 1102.

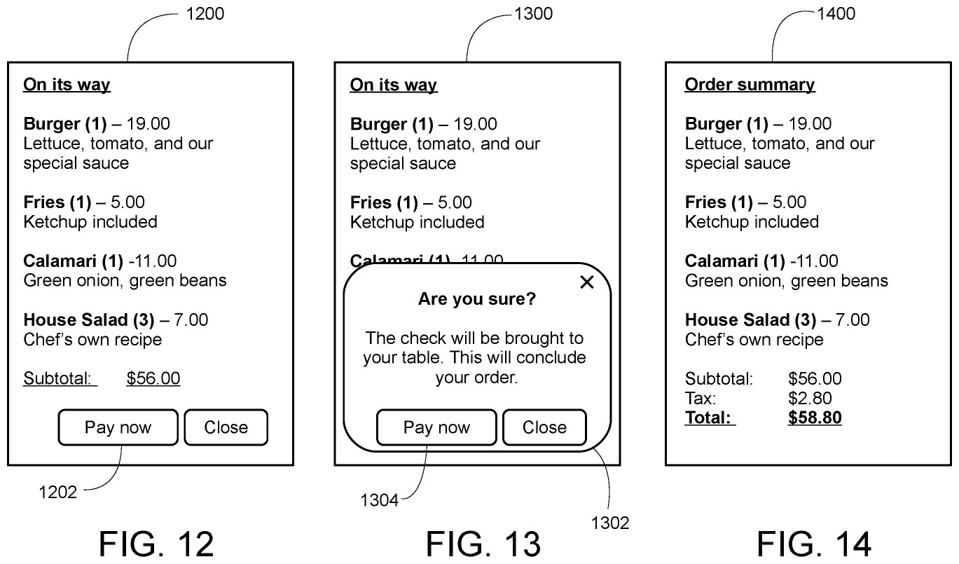

FIG. 12 illustrates a UI screen 1200 allowing users to check the items that have been ordered and that are on their way. This screen also includes a “Pay now” button 1202 in the event the user wishes to process payment for the order.

FIG. 13 illustrates a UI screen 1300 showing a pop-up alert 1302 that appears when the user presses one of the “Pay now” buttons 1202. The pop-up alert 1302 confirms that the user wants to conclude the order and make payment. Assuming the user clicks the “Pay now” button 1304, an alert is sent to a staff device 124 to cause a staff member to come to the restaurant table associated with the order and collect payment.

FIG. 14 illustrates a UI screen 1400 illustrating an order summary displayed after the order is concluded. The order summary page 1400 displays the total amount of the bill such as including tax. A recommend gratuity such as 15% may also be included on this screen if desired.

In this embodiment, payment is still manually collected from patrons by restaurant staff in the regular manner utilizing either cash or credit card via the restaurant's regular POS system 118. The order server 116 simply dispatches staff members to go to the restaurant table via one or more alerts sent to staff device(s) 124. However, of course, other embodiments are also possible where the patron submits the payment directly via their patron device 102 such as by entering their credit card details into a secure payment web page provided by the webserver 220 or another payment processor 126 on the Internet 122. An example embodiment is shown later with respect to FIGS. 19 and 20.

FIG. 15 illustrates a UI screen 1500 allowing a patron device 102 to add another patron device 102 to the order in a daisy chain manner according to an exemplary embodiment. The process of adding a new patron device 102 to the order is initiated by the user clicking the “Add device” button 1502.

As mentioned earlier, it may be desirable for some patrons to be able to add other patron devices 102 to an existing order without requiring the assistance of restaurant staff. In some embodiments, the first patron device 102 added to the order is considered a “trusted device” and the webserver 220 includes the “Add device” button 1502 on web pages sent to this trusted device 102 thereby giving it the ability to add additional patron devices 102 to the order. For security reasons, other patron devices 102 are not provided the “Add device” button 1502 by the webserver 220 and therefore do not have the ability to add further patron devices 102.

In yet other embodiments, all patron devices 102 added to an order are considered “trusted devices” and the webserver 220 includes the “Add device” button 1502 thereby giving each the ability to add more patron devices 102 to the order.

FIG. 16 illustrates an example of a trusted patron device A 102 displaying a QR code 502 associated with an order in order to add a new patron device B 102 to the order according to an exemplary embodiment. After pressing the “Add device” button 1502 on the trusted patron device A, the webserver 220 generates a QR code 502 having a code uniquely identifying the order 700 with which patron device A is already associated. In some embodiments, the code and the QR code 502 are both the same as what was utilized previously to add patron device A to the order 700. However, this is not a requirement and for increased security, the order controller 222 may generate a new code/QR code 502 associated with the order 700 such as by adding a new row in the order codes database table 212 for the particular order identifier.

The QR code 502 may be displayed by patron device A in a manner similar to as shown in FIG. 5. The untrusted patron device B then scans the code 502 and begins the process of authentication described above in FIG. 3 starting at step 308. Assuming the authentication process succeeds and reaches the “yes” branch of step 318, the new patron device B is then added by the order controller 222 to the order 700. This is shown in FIG. 17 where both patron devices 102 (devices A and B) can be utilized to order food items under the same order history 214.

The authentication process of FIG. 3 may also be enhanced and/or changed in other embodiments. For instance, rather than requiring a staff device 124 to initiate the new order at step 300, it is also possible to allow a patron device 102 to initial the order at step 300a. In some embodiments, a table-specific printed QR code may be provided on each restaurant tabletop that upon scanning provides a link encoded therein to the browser that redirects the web browser of the patron device 102 to the webserver's 200 login page. The QR code may additionally have embedded therein a restaurant table identifier such that each restaurant table has a unique but otherwise static QR code. When the webserver 220 running on the order server 116 receives the request at step 302, it will then create a new unique order code and the process proceeds as normal starting at step 302. This will then cause a host or other staff member to arrive at the restaurant table and show a dynamically generated QR code 502 that includes the unique code for identifying the order at step 306.

The above-described authentication embodiments have a common feature that the QR code 502 including the unique code for identifying the order is displayed by a trusted computing device. The trusted computing device may be a staff device 124 such as illustrated in FIG. 3. Likewise, the trusted computing device may be another patron device 102 that is already associated with the order such as patron device A shown in FIG. 16. However, it is also possible to reverse the authentication process such that the QR code 502 including the unique identifier is displayed on the untrusted device for scanning by the trusted device.

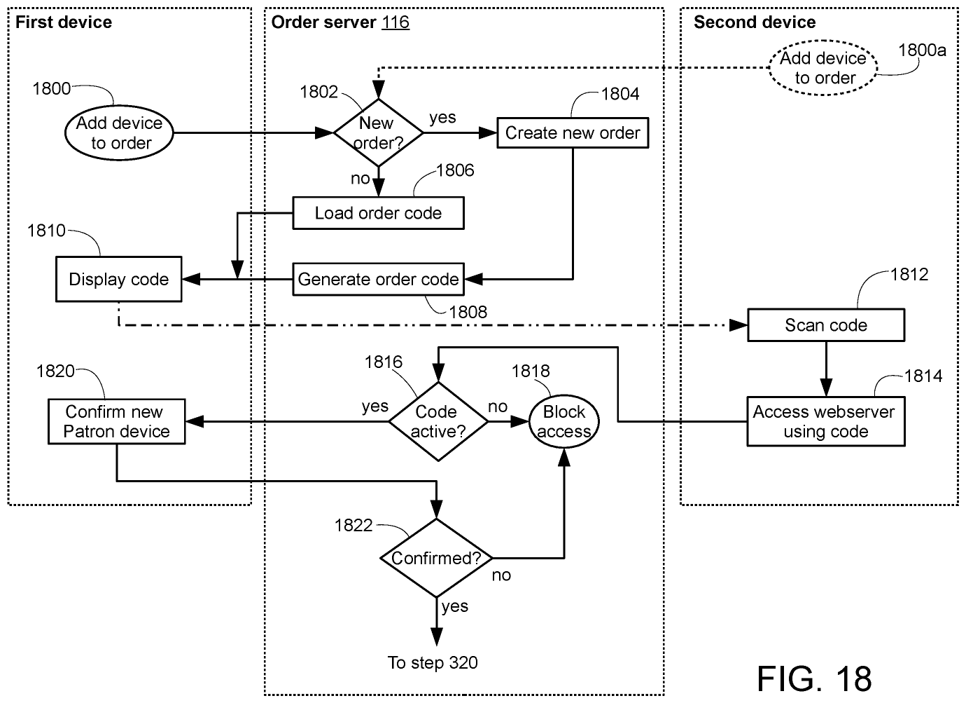

FIG. 18 shows an authentication process for adding a new patron device 102 to an order where the unique code for identifying the order is displayed on either a trusted or untrusted device according to an exemplary embodiment.

The steps of FIG. 18 indicated as being performed by the first device may be performed by one or more processors of the first device executing software such as a web browser or other application loaded from a storage device of the first device. The steps of FIG. 3 indicated as being performed by the order server 116 may be performed by processors 200 of the order server 116 executing the software including the order controller 222, web server 220, and POS converter loaded from the storage device. The steps of FIG. 3 indicated as being performed by the second device may be performed by one or more processors of the second device executing software such as a web browser or other application loaded from a storage device of the second device. The steps of the flowchart are not restricted to the exact order shown, and, in other configurations, shown steps may be omitted or other intermediate steps added.

In the following description, the terms first device and second device are utilized in order to not specify which is the trusted device and which is the untrusted device. The rows of the following table summarize two options for first device and second device:

| | First device | Second device |
|---|---|---|
| Option 1 | Trusted | Untrusted |
| | (e.g., staff device 124 or | (e.g., new patron device 102) |
| | already-authorized patron | |
| | device 102) | |
| Option 2 | Untrusted | Trusted |
| | (e.g., new patron device 102) | (e.g., staff device 124 or |
| | | already-authorized patron |
| | | device 102) |

The process begins at either step 1800 or 1800a when the process for adding a new patron device 102 is initiated on either the first or second devices. In other words, the process can be initiated on either the trusted or untrusted device. On the trusted device, it may involve a host staff doing a check-in of a new patron at the restaurant 104 or may involve a user of a trusted patron device 102 already associated with the order clicking an “Add device” button 1502. On the untrusted device, it may involve a new patron at the restaurant 104 sitting down at an empty restaurant table and scanning that table's QR code, for example.

At step 1802, the order server 116 determines whether the request to add a new patron device 102 is associated with an existing order or a new order. In some embodiments, the order server 116 determines the request is for a new order when the host staff initiates the request for a new restaurant table. Likewise, the order server 116 determines the request is for a new order when a new patron device 102 initiates the request for a restaurant table that does not have any active order in the orders status. In the case of a new order, control proceeds to step 1804. Alternatively, for existing orders such as when the request was initiated from a trusted patron device 102 already associated with an active order, control proceeds to step 1806.

At step 1804, the order server 116 creates a new order. This step corresponds to step 302 in FIG. 3 and therefore a repeated description is omitted for brevity.

At step 1806, the order server 116 loads the order code for the existing order such as by searching the order codes database table based on an order identifier (e.g., restaurant table number) included in the request received at step 1802.

In embodiments where the order code is not saved in the order codes database table 212, for example because the code was generated utilizing a 2-way (reversable) encryption function, the order server 116 may instead regenerate the order code by encrypting the same information as was utilized to generate the original code. Assuming the patron name and order ID were encrypted to generate the code, at step 1802 the order server may again encrypt these fields of data to form the order code that uniquely identifies the order.

This step 1802 may also involve the order server 116 encoding the code into a QR code image 502 and sending the code to the first device.

At step 1808, the order server 116 generates a new order code and sends it to the first device. This step corresponds to step 304 in FIG. 3 and therefore a repeated description is omitted for brevity.

At step 1810, the first device displays the code thereby allowing scanning by the second device. The code may be displayed in the form of a QR code 502 as shown in FIG. 5, for example. This step generally corresponds to step 306 except it is not a requirement in step 1810 that the first device be a staff device 124.

At step 1812, the second device scans the code. This step generally corresponds to step 308 of FIG. 3 except it is not a requirement in step 1812 that the second device be the new patron device 102.

At step 1814, the second device access the webserver 220 to thereby provide the webserver 220 with the code. This step generally corresponds to step 310 except that in step 1814 it is not a requirement that the second device be the new patron device 102.

At step 1816, the order server 116 checks whether the received code is active. This step corresponds to step 312 and a repeated description is omitted.

At step 1818, the order server 116 blocks access. This step generally corresponds to step 314 and a repeated description is omitted.

At step 1820, the first device displays a confirmation screen 600 allowing a user of the first device to confirm that the new patron device 102 should be added to the order. This step generally corresponds to step 316 in FIG. 3, however, in step 1820 it is not a requirement that the first device be the staff device 124.

At step 1822, the order server 116 determines whether the confirmation response authorizes adding the new patron device 102 to the order. This step corresponds to step 318 in FIG. 3 and therefore a repeated description is omitted for brevity.

An example use-case scenario is as follows. A group of six people, each carrying a mobile phone 102, arrive at a restaurant 104. A host at the restaurant 104 confirms that the group has a reservation, assigns the party to restaurant table “198” and initiates the new device adding process utilizing a tablet computer carried by the staff member (FIG. 4). The tablet computer displays a QR code 502 (FIG. 5) and the member of the party that made the reservation uses her personal mobile phone 102 to take a picture of (i.e., scan) the QR code 502 (step 308). The mobile phone 102 decodes the QR code and displays a link which the user clicks (step 310), which results in a confirmation screen 600 being displayed to the host on the tablet computer (FIG. 6). The host clicks the “confirm” button 602 and guides the party to their assigned restaurant table.

From this point onwards, the mobile phone 102 of the initial party member shows the restaurant menu (FIG. 9) and can be utilized to order any desired food items (FIGS. 10 to 15).

Because the party members all have their own mobile phones, each person in the group also desires access to the menu so the initial party member clicks the “Add device” button 1502 (FIG. 15) and a QR code 502 is displayed on her mobile phone 102 (FIG. 5), which is now a “trusted” patron device 102. Each of the other members of the party take a picture of that QR code 502 (step 308), which causes their respective devices 102 to thereafter pass the unique code for the order to the webserver 220 (step 310). A confirmation screen 600 (FIG. 6) is then displayed on the initial party member's mobile phone 102 requesting confirmation to add an additional five (5) new patron devices 102 to the order. Authorization is granted by the user clicking the “confirm” button 602 and now all the members of the party can browse the menu and order food.

A plurality of possible other configurations may also be performed at the beginning of an order including entering a seat number, taking a picture of a patron's face for runner to associate food order to seat, selecting or specifying allergies, selecting preferred payment methods (e.g., cash, online payment, etc.), etc. In some embodiments, the order server 116 utilizes the webserver 220 to generates one or more web pages to have customers enter their card information before actually ordering. The order server 116 then confirms the credit card information is valid by querying the payment processors 126. A pre-authorization for the expected amount may also be sent to the payment processor by the order server 116. These actions to confirm the credit card by the order server 116 serve as another fraud check and ensures that the credit card is valid for payment before the food is actually delivered.

In some embodiments, food items requested to be ordered on the subsequently added patron devices 102 must be confirmed by the initial patron device 102. This is done by the order server 116 checking at step 332 whether the order was received from the initial patron device 102 or from a subsequently added patron device 102. When the food item order is received from the initial patron device 102, the POS action item is confirmed and control proceeds to step 334. However, if the order is received from a secondary patron device 102, then the order server 116 will not deem that order message to be a POS action item, instead, control returns from step 332 back to step 322 where web session data is sent back to the initial patron device 102 to confirm the order. In this way, the initial party member, i.e., the person paying the bill, can confirm all items added to the bill.

In some embodiments, the feature of whether the initial patron device 102 needs to confirm all food items ordered may be a user configuration settings. Either the host may set this on a per order basis such as when performing the check-in process, or the initial patron device 102 may have a menu option to either enable or disable the preview requirement. For example, in some situations, the person paying the bill may not want to preview all food items ordered.

Alternatively, in some embodiments, each patron device 102 under a single ordered is treated as a separate bill. In this way, no preview is required and food items ordered by a particular patron device 102 are paid for by the user of that patron device 102. Again, whether or not all food items ordered by patron devices 102 are placed on a single bill or with multiple bills (and/or combinations thereof where certain subgroups of patron devices 102 are on one bill and others are on separate bills) may be user-configurable settings specified by either the restaurant staff or the patrons themselves.

FIGS. 19 and 20 illustrate an embodiment where the system 100 facilitates “split bill” functionality at a restaurant. Split bills at restaurants are a common source of trouble for both servers and patrons. A great deal of stress is therefore encountered by a typical server when a large group requests a plurality of divisions of bills and all order together. Sometimes, groups only request the bill be split after the meal is finished and its time consuming for restaurant staff to figure out how to split all the food items appropriately. To help solve with these bill splitting problems, in some embodiments, the system 100 facilitates with splitting bills by allowing any number of mobile devices 102 to be added to a single table's order such as by utilizing the above-described daisy chaining technique. A large group can thereby all quickly gain access to order food items at the table utilizing the respective mobile devices 102 of the party members. The order server 116 stores a record in the order histories 214 indicating device identifiers from which mobile device each food item was ordered. Thereafter, when it is time to pay for the meal, the entire set of food items ordered for the table (i.e., the entire order) is displayed on each mobile device; however, only the food items actually ordered by each respective are pre-selected for payment on that particular mobile device.

Taking a simple example, assume two mobile devices 102 A, B are utilized to order food items. FIG. 19 shows a pay now screen for the first mobile device 102, i.e., device “A” where all food items of the table are shown but the food items actually ordered utilizing device “A” are preselected (i.e., highlighted) for payment. Likewise, FIG. 20 shows a pay now screen for the second mobile device 102, i.e., device “B”. Again, all food items are the table are shown and the particular food items ordered utilizing device “B” are preselected for payment on device “B”.

A benefit of this embodiment is that, by default, the bill is split such that each mobile device 102 can easily be utilized to pay for the portion of the food items that was ordered on that mobile device. Furthermore, this embodiment allows any patron to pay for any food item ordered at the table. The table or group's food items are still collected together under a single order and all devices may be linked to said order utilizing a same QR code, for example. This is useful because a particular person may want to treat everyone else at the table and may therefore select to pay for food items that were ordered utilizing other devices 102 at the table. The order server 116 beneficially splits the bill on a per mobile device 102 basis, but allows the group members themselves to adjust the bill split in any manner desired without involvement of restaurant staff. Human staff members such as waitstaff do not need to take careful notes at time of ordering and do not need to worry about patrons wanting to split the bill after the meal is done. Stress on staff of large groups splitting bills is thereby greatly reduced.

In some embodiments, the order server 116 will dynamically remove items for payment on the payment screen of all mobile devices 102 once they are paid for. In other words, once the burger and soda indicated for payment in FIG. 19 are paid for, these two items will dynamically be removed by the order server 116 from the payment screen shown in FIG. 20. In some embodiments, a “select all” button may be provided to allow a patron on a particular mobile device 102 to quickly select all food items on the order regardless of which mobile device was utilized to order said items. Likewise, other buttons (not shown) may also be included such as a filtering for only items ordered on “this device” or to filter for items ordered on any other device in the party, which may be selected by guest name is some cases where the order server 116 has said information.

As mentioned earlier, FIGS. 19 and 20 also illustrate an example where payment is performed via credit card right from the mobile device(s) 102. This is beneficial to not trouble restaurant staff to come to the table to collect payment. Gratuities may be automatically added as illustrated, and, behind the scenes, the order server 116 may further allocate a portion of each bill to the restaurant and another portion to the order system 100.

In some embodiments, the confirmation step 316 and/or step 1820 shown respectively in FIGS. 3 and 18 may be omitted. This can be done by modifying step 318 in FIG. 3 to have the “yes” branch from step 312 proceed directly to step 320 to add the patron device to the order. In this way, assuming an untrusted device 102 scans a valid code (at step 308), this will result in the received code being determined to be valid and active at step 312, and the order server 116 therefore immediately adds the patron device 102 from which the valid code was received to the order associated with the code. Likewise, step 1816 in FIG. 18 may be modified to have its “yes” branch proceed directly to step 320 in a similar manner.

In some embodiments, whether the confirmation step 316 and/or step 1820 utilizing a separate device is required is a user-configurable setting. In some embodiments, the first patron device 102 added to a new order requires confirmation on the device that displayed the QR code; however, all subsequent patron devices 102 added to the same order do not require confirmation on the device that displayed the QR code.

In an exemplary embodiment, the web application design of the system 100 includes a table-side ordering system with full front facing application for the patrons as well as a staff portal for order fulfillment, checking in patrons, etc. Information streams are real time over HTTP and WS technologies. Dynamic QR code authentication is secure and eliminates fraudulent orders and actions a restaurant would suffer from with only static QR codes.

The order server 116 and associated system 100 may be implemented and managed by a third party vendor separate from the restaurant 104 with business model similar to payment processing companies where the vendor takes a fee such as a percentage of every order that goes through the service. Other fees such as a flat fee for every order or per unit of time such as a monthly fee are applied in some embodiments. The system 100 is designed in some embodiments to have dynamic subdomains for the URL encoded in the QR codes 502 so every restaurant 104 has its own branded domain (e.g. restaurant-name.example.com).

Exemplary benefits of some embodiments include the speed and convenience with which patrons at the restaurant 104 can begin ordering food. There is no sign-up process required and therefore privacy is maintained for patrons. There is no contact information required and patrons may stay completely anonymous. The actual authentication process in some embodiments merely involves taking a picture of a QR code 502 on a first device and clicking a confirmation button 602 on another device to authorize food to be ordered from a new patron device 102. Communications are done over a guest W-Fi network 110 at the restaurant 104, which may beneficially also provide Internet 122 access to patrons as well.

In some embodiments the guest Wi-Fi network 110 is encrypted further enhancing privacy and security; however, even in embodiments where the guest Wi-Fi network 110 is an open (unencrypted) wireless network, communications between the patron devices 102 and the webserver 220 are still preferably done via the HTTPS protocol to ensure that all web session data is encrypted while being sent over radio airwaves.

Security is also built-in to the authentication process because the QR code 502 includes a unique order code that corresponds to a single active order at the restaurant 104. Once the order is no longer active, patron devices 102 that were authenticated under that order are no longer able to add additional food items to that order. Likewise, new patron devices 102 that scan the QR code 502 after the order is no longer active are blocked by the order server 116 from gaining access to the order. In some embodiments, the QR code is a one-time code that is never utilized again once the order is completed.

Fraud prevention is also built-in because, even when an order code is active and the unique order code identifying that order is received by the webserver 220, there is still a confirmation check required in some embodiments between the new patron device 102 and a trusted device such as a staff device 124 or an already authorized patron device 102 under the same order. Since the party members all know each other and are physically beside each other at the restaurant 104, they will know whether one of the party members is trying to add a new patron device 102 to the order. If a confirmation request is received and no one in the party is trying to add a new device, the confirmation request screen 602 can simply be ignored and/or denied, thereby preventing whoever is trying to add that new device 102 from gaining access to the order. The process of cryptographically signing values to form the code verifies that the device 102 is trusted, and the unique pieces of information contained within the data (e.g. last name or table number) requires on premises knowledge as a way of preventing fraud in addition to and/or instead of requiring the confirmation check to be performed on the device that displayed the QR code.

In some embodiments, an authorized patron device 102 may initiate adding a new patron device 102 and may act as a trusted device to both display the QR code 502 for scanning by the new device 102 and to allow the user of the authorized patron device 102 to confirm adding the new patron device 102 to the order. In this way, load on staff members of the restaurant 104 is reduced. A host may simply authorize an initial patron device 102 and from that point onwards the initial patron device 102 is deemed a trusted device and the members of the party can all be added by scanning a QR code 502 displayed on the initial patron device 102 instead of a staff device 124. Daisy chaining of adding patron devices 102 is possible in some embodiments where each newly added patron device 102 becomes a trusted device and can thereafter add another patron device 102 to the same order. Large groups of people each with their own mobile phone 102 can thereby very quickly be added to a single order at the restaurant 104 with very little involvement from staff members.

In some embodiments, the confirmation check (steps 316/1820) is performed on a designated device instead of the device that originally displayed the QR code for scanning. In an example, the first patron device 102 added to the order may become the “designated device” and all subsequent patron devices 102 added to the order, even if initiated on another trusted patron device 102, are required to be confirmed on the designed patron device 102. This may be beneficial in situations where the designated patron device 102 is utilized by the person who will be paying the restaurant bill. In some embodiments, the selection of the designated patron device is a user-configurable setting, such as selected by restaurant staff upon checking in a new party.

In an exemplary embodiment, a system 100 for ordering and purchasing food utilizing a patron device 102 at a restaurant 104 includes a staff device 124 and an order server 116. The order server 116 creates an order and a code identifying the order. The code is sent to the staff device 124 where it is displayed. The patron device 102 scans and sends the code to the order server 116, which determines whether the received code matches a still-active order. When yes, the order server 116 sends a confirmation request to the staff device 124 to query whether the patron device 102 is authorized to be added to the order. When yes, the order server 116 stores an association of the patron device 102 with the order and adds to the order food items specified messages received from the patron device 102. The patron device 102 may thereafter be trusted and utilized to add subsequent patron devices 102 to the order in a similar manner without involvement of the staff device 124.

Although the invention has been described in connection with preferred embodiments, it should be understood that various modifications, additions and alterations may be made to the invention by one skilled in the art without departing from the spirit and scope of the invention. For example, although the above-description has focused on a food ordering system at a restaurant 104 for illustration purposes, the present invention is equally applicable to any business wishing to allow patrons to order services utilizing patron devices 102. Examples include restaurants, hotels, motels, resorts, hospitals, cruise ships, movie theatres, airlines, airports, shopping centers, passenger trains, coffee shops, etc.

Although the unique order code described above is separately generated from the web session identifier, in some embodiments, the order code and the web session identifier are one and the same.

Although the above embodiments have been described with the order server 116 generating the QR code image 502 at steps 304, 1808; in some embodiments, the URL is passed to the first device (i.e., the staff device 124 or the patron device 102 that is going to display the QR code) in order that the first device can itself generate the QR code image 502 for encoding that URL. Offloading the QR code 502 generation to the first device is beneficial to reduce processing requirements of the central order server 116.

Although QR codes 502 are beneficial and supported by most current smart phones, other embodiments may utilize other types of codes. For instance, the code may simply be displayed as a text such as a password that the user manually enters into their phone rather than scanning. Likewise, other authentication methods may be offered in addition to the code-based authentication. For instance, login via phone number may be offered as a QR fallback method. In some embodiments radio-frequency integrated circuit (RFIC) transmitters and/or receivers are utilized in each mobile device to pass codes. For example, a patron may “scan” the code from a staff member's device by bumping the patron's mobile device 102 against the staff device 124. Similarly, patron devices 102 may be daisy chained onto the order by people in the group bumping their phones together. Other types of wireless technologies may be utilized in a similar manner in other embodiments to fulfil the “display” and “scan” steps 304, 308, 1810, 1812.

In some embodiments, rather than having a human host staff member, the host at the front of the restaurant 104 is replaced with an automated terminal (e.g., a kiosk) that walks people through the check-in process. For example, the user adds last name and then order server 116 automatically assigns restaurant table number and generates the QR code 502 for scanning.

Although each of the order server 116, gateway, and POS system 118 are illustrated in FIG. 1 as being separate computing devices, in some embodiments these devices are all integrated on a single computer server. For instance, in some embodiments, the order server 116 of FIG. 2 further includes software and data for performing the functionality of the POS system 118 and gateway.

Either or both of the order server 116 and/or the POS system 118 may also be moved onto the Internet 122 to thereby become a cloud-based order server 116 and/or POS system 118.

In yet other embodiments, the gateway and Internet 122 access may be removed from the system. This may be beneficial in certain applications where Internet 122 access is not available such as remote restaurants 104, for example.

In above embodiments, the order server 116 acts as a webserver 220 that interacts with patron devices 102 running standard web browsers. This is beneficial to prevent the need for the patron devices 102 to install any new software prior to being able to utilize the system. However, the order server 116 may also include “app server” software 208 that interacts over a computer network with a specialized application running on the patron device 102. This may be beneficial to better support loyal patrons such as repeat patrons who have taken the time to install a custom application for the restaurant 104. Likewise, points and rewards may be accumulated and redeemed as tracked by the order server 116, especially when a custom application is utilized.

Rather than or in addition to a guest Wi-Fi network 110, in some embodiments, patron devices 102 communicate with the order server 116 via other networks and communications paths. For instance, the patron device 102 in some embodiments communicates with the order server 116 via the Internet 122, which may be accessed by the patron device 102 utilizing a cell phone data plan, for example.

Although the above system 100 enables patron devices 102 to order food items and the order controller 116 sends an electronic message to the POS system 118 at the restaurant 104—see step 334—this may be modified in other embodiments. For instance, rather than sending an electronic order message to the POS system 118 at step 334, step 334 is modified in some embodiments to simply display a list of the food items ordered. The order may be displayed on a staff device 124 such as a tablet device carried by restaurant wait staff or on a fixed kiosk checked by waitstaff. Upon seeing the order, a staff member may then manually enter the order into the POS system 118. Alternatively, the kitchen staff may read the order from the screen and directly prepare the food without utilizing any additional POS system 118.

In the above description, the term “food” and “food items” are generally intended to include all types of edible items including drinks and food. Although a single code is scanned and passed back to the web server 220 for confirmation in above embodiments, in other embodiments, the URL may include multiple codes, or the code may be separated into multiple values.

Although encrypted values are utilized to form the code in preferred embodiments, other types of codes such as hash values formed by a hashing function may be utilized in other embodiments. Both one-way functions (hashing) as well as reversible (2-way) functions (encryption) may be utilized in different embodiments.

With a reversible function such as encryption, the order server 116 generates the code on the fly by encrypting the data from the database table (e.g., restaurant table number, UUID, patron last name, etc.) utilizing a private key. Then, when the request is made to the auth endpoint (FIG. 3: steps 310-312; FIG. 18: steps 1814-1816) the server 116 uses the private key to decrypt the code and obtain the data again. The order controller software 222 then immediately has the information available in plaintext needed to query and verify the order status. As exemplified above, the order code in such situations does not necessarily have to be stored in the database—i.e., the order codes 212 database table can be omitted in some embodiments. Instead, the code can be dynamically generated via an encryption function that encrypts the data needed to verify the order status. The QR association process is therefore entirely dynamic based on information flowing through the system as opposed to a static code that is stored in the database.

However, in addition to reversable codes such as encrypted messages and non-reversable values such as hash values, other types of codes may also be utilized in a similar manner. For instance, in some embodiments, a random value selected from a large number space can be utilized as long as there is no collision in the value with another code for an active order. A large enough range of acceptable values would suffice to ensure the code is unique for the order (e.g. an order UUID or hash value). Utilizing a reversible encryption function is beneficial to avoid hash collisions and also to have the ability to change the private key periodically to further heighten the security of the system; however, it is to be understood that other embodiments can utilize other types of codes. In some embodiments, the code is passed as parameter included in a URL embedded in a QR code while in some embodiments the code is passed as a part of the path of the URL.

The system 100 may also be utilized to provide enhanced data to restaurant owners such as tracking average order times for particular food items, feedback on inventory, food wastage, and “dripping orders” where the order server 116 will automatically pass food item preparation commands to the kitchen staff in a spaced out manner. The dripping orders functionality may be activated by the order server 116 at certain times or in response to certain thresholds being met such number of orders not yet passed to kitchen. Machine learning techniques may be applied by the system 100 in both the kitchen and front of house regarding these statistics and data analysis.

The system 100 may be beneficially coupled via an application programming interface (API) to any number of additional systems. The POS system 118 is one example; however, APIs are not limited to only the PMS system, other systems such as external inventory management systems may be coupled to the order server 116 in a similar manner.

Although the above description has focused on session based requests (i.e., web sessions 216), in other embodiments, stateless authentication and stateless requests may also be utilized. For example, the order server 116 in some embodiments encrypts a dictionary of data (e.g. {“OrderId”:1, Datetime: “2021-03-21 16:09:27.361505”, “table”:57}), and then checks the signature to first verify its authenticity. The order server 116 may then decrypt and deserialize the data to get a dictionary in a server side language. The order server 116 may then check that the order is active and data is correct, which in turn authenticates this request. This is the per request and stateless authentication. Stateless authentication may be particularly beneficial for non-monolithic implementations. As touched on before, the system 100 may have front end apps that communicate with the API via a stateless auth token. Embodiments are possible such as session based (when utilizing a monolithic codebase) to stateless when breaking up the codebase into an API and frontend apps, for example.

Order payment may also not be tired to order open/closed state in other embodiments. For example, in some embodiments, once the customer has paid, the order is automatically closed; however, in other embodiments, the order stays open for as long as the restaurant keeps it open. In particular, with the embodiments facilitating split bills and continuous ordering, the waitstaff server may close the order manually such as by pressing a button on the staff mobile device 124 in order to send an order close message to the order server 116 to close a particular order.

The order server 116 functionality described above and as shown in flowcharts of FIG. 3 and FIG. 18 in particular may be implemented by software executed by one or more processors operating pursuant to instructions stored on a tangible computer-readable medium such as a storage device. Examples of the tangible computer-readable medium include optical media (e.g., CD-ROM, DVD discs), magnetic media (e.g., hard drives, diskettes), and other electronically readable media such as flash storage devices and memory devices (e.g., RAM, ROM). The computer-readable medium may be local to the computer executing the instructions, or may be remote to this computer such as when coupled to the computer via a computer network such as the Internet 122. The processors may be included in a general-purpose or specific-purpose computer that becomes the order server 116 or any of the above-described devices as a result of executing the instructions.

In other embodiments, rather than being software modules executed by one or more processors 200, the order server 116 functionality and or functionality of other devices described above may be implemented as hardware modules configured to perform the above-described functions. Examples of hardware modules include combinations of logic gates, integrated circuits, field programmable gate arrays, and application specific integrated circuits, and other analog and digital circuit designs.

Functions of single units illustrated above may be separated into multiple units, or the functions of multiple units may be combined into a single unit. For example, one or more of the webserver 220, order controller 222, and POS converter may be implemented internal or external to the order server 116.

Unless otherwise specified, features described may be implemented in hardware or software according to different design requirements. In addition to a dedicated physical computing device, the word “server” may also mean a service daemon on a single computer, virtual computer, or shared physical computer or computers, for example. All combinations and permutations of the above described features and embodiments may be utilized in conjunction with the invention.

What is claimed is:

1. A system for ordering and purchasing food utilizing a plurality of patron computing devices at a restaurant, the system comprising:
a staff computing device coupled to a computer network; and
an order server coupled to the computer network;
wherein, by executing a plurality of software instructions loaded from one or more storage devices, the order server is configured to:
create an order and store a code for uniquely identifying the order in the one or more storage devices;
send the code to a first device via the computer network to thereby cause the first device to display the code on a display of the first device and allow a second device to scan the code, wherein the first device is one of the staff computing device and a first patron computing device, and the second device is another of the staff computing device and the first patron computing device, the second device being different than the first device;
receive a received code from the second device via the computer network;
determine whether the received code matches the code uniquely identifying the order;
in response to determining that the received code matches the code, store an association of the first patron computing device with the order in the one or more storage devices and add to the order one or more first food items as specified in one or more messages received from the first patron computing device via the computer network;
receive a second received code from a second patron device via the computer network, wherein the second patron device determined the second received code as a result of interacting with the first patron computing device;
determine whether the second received code matches the code uniquely identifying the order; and
in response to determining that the second received code matches the code, store an association of the second patron computing device with the order in the one or more storage devices and add to the order one or more second food items as specified in one or more messages received from the second patron computing device via the computer network;
whereby both the first patron computing device and the second patron computing device add one or more food items to the order.

2. The system of claim 1, wherein the order server is further configured to:
store a record of which of the food items of the order were ordered utilizing the first patron computing device and which of the food items of the order were ordered utilizing the second patron computing device;
send a first billing screen to the first patron computing device, the first billing screen including all of the food items of the order selectable for payment where only the first food items ordered on the first patron computing device are preselected for payment; and
send a second billing screen to the second patron computing device, the second billing screen including all of the food items of the order selectable for payment where only the second food items ordered on the second patron computing device are preselected for payment.

3. The system of claim 1, wherein the order server is further configured to:
in response to determining that the received code matches the code, send a confirmation request to the first device to thereby query a user of the first device whether they authorize adding the first patron computing device to the order;
receive a confirmation response from the first device via the computer network; and
in response to the confirmation response authorizing adding the first patron computing device to the order, store the association of the first patron computing device with the order in the one or more storage devices and add to the order the one or more food items as specified in the one or more messages received from the first patron computing device via the computer network.

4. The system of claim 1, wherein the order server is further configured to generate and send a food order message to a point of sale (POS) system of the restaurant, the food order message including the one or more food items of the order.

5. The system of claim 1, wherein the order server is further configured to send a food order summary to the staff computing device thereby allowing the staff computing device to display the food order summary to a user, the food order message including the one or more food items of the order.

6. The system of claim 1, wherein the order server is further configured to create the order in response to a new order message received from the staff computing device via the computer network.

7. The system of claim 6, wherein the new order message includes a table identifier associating the order with a table at the restaurant identified by the table identifier.

8. The system of claim 1, wherein the order server is further configured to generate a QR code encoding the code and to send the code to the first device via the computer network by sending the QR code to the first device via the computer network.

9. The system of claim 8, wherein the order server is further configured to generate the QR code to further encode a uniform resource locator (URL) including an address where the order server is reachable on the computer network by the second device.

10. The system of claim 9, wherein the code is a parameter included in the URL.

11. The system of claim 1, wherein the code is an encrypted value and the order server is further configured to generate the code utilizing an encryption function.

12. The system of claim 1, wherein, in order to add a third patron device to the order, the order server is configured to:
send a second code uniquely identifying the order to a third device via the computer network to thereby cause the third device to display the second code on a display of the third device and allow a fourth device to scan the second code, wherein the third device is one of a trusted computing device associated with the order and the third patron computing device, and the fourth device is another of the trusted computing device and the third patron computing device, the fourth device being different than the third device, and the trusted computing device being either the staff computing device or the first patron device already added to the order;
receive a third received code from the fourth device via the computer network;
determine whether the third received code matches the second code uniquely identifying the order;
in response to determining that the third received code matches the second code, store an association of the third patron computing device with the order in the one or more storage devices and add to the order one or more third food items as specified in one or more messages received from the third patron computing device via the computer network.

13. The system of claim 12, wherein the second code is the code for uniquely identifying the order as previously stored in the one or more storage devices by the order server.

14. The system of claim 1, wherein the order server is configured to daisy chain authorization for adding subsequent patron devices to the order by deeming each newly added patron device to thereafter be a trusted computing device associated with the order.

15. An order server for managing orders at a restaurant, the order server comprising:
one or more network interfaces coupled to a computer network;
one or more storage devices; and
one or more processors coupled to the one or more network interfaces and the one or more storage devices;
wherein, by executing a plurality of software instructions loaded from one or more storage devices, the one or more processors are configured to:
create an order and store a code for uniquely identifying the order in the one or more storage devices;
send the code to a first device via the computer network to thereby cause the first device to display the code on a display of the first device and allow a second device to scan the code, wherein the first device is one of a staff computing device and a first patron computing device at the restaurant, and the second device is another of the staff computing device and the first patron computing device, the second device being different than the first device;
receive a received code from the second device via the computer network;
determine whether the received code matches the code uniquely identifying the order;
in response to determining that the received code matches the code, store an association of the first patron computing device with the order in the one or more storage devices and add to the order one or more first food items as specified in one or more messages received from the first patron computing device via the computer network;
receive a second received code from a second patron device via the computer network, wherein the second patron device determined the second received code as a result of interacting with the first patron computing device;
determine whether the second received code matches the code uniquely identifying the order; and
in response to determining that the second received code matches the code, store an association of the second patron computing device with the order in the one or more storage devices and add to the order one or more second food items as specified in one or more messages received from the second patron computing device via the computer network;
whereby both the first patron computing device and the second patron computing device add one or more food items to the order.

16. The order server of claim 15, wherein the one or more processors are further configured to:
store a record of which of the food items of the order were ordered utilizing the first patron computing device and which of the food items of the order were ordered utilizing the second patron computing device;
send a first billing screen to the first patron computing device, the first billing screen including all of the food items of the order selectable for payment where only the first food items ordered on the first patron computing device are preselected for payment; and
send a second billing screen to the second patron computing device, the second billing screen including all of the food items of the order selectable for payment where only the second food items ordered on the second patron computing device are preselected for payment.

17. The order server of claim 15, wherein, in order to add a third patron device to the order, the one or more processors are further configured to:
send a second code uniquely identifying the order to a third device via the computer network to thereby cause the third device to display the second code on a display of the third device and allow a fourth device to scan the second code, wherein the third device is one of a trusted computing device associated with the order and the third patron computing device, and the fourth device is another of the trusted computing device and the third patron computing device, the fourth device being different than the third device, and the trusted computing device being either the staff computing device or the first patron device already added to the order;
receive a third received code from the fourth device via the computer network;
determine whether the third received code matches the second code uniquely identifying the order;
in response to determining that the third received code matches the second code, store an association of the third patron computing device with the order in the one or more storage devices and add to the order one or more third food items as specified in one or more messages received from the third patron computing device via the computer network.

18. The order server of claim 15, wherein the one or more processors are further configured to daisy chain authorization for adding subsequent patron devices to the order by deeming each newly added patron device to thereafter be a trusted computing device associated with the order.

19. A method of managing orders by an order server for a restaurant, the method comprising:
creating an order by the order server and storing a code for uniquely identifying the order in one or more storage devices;
sending the code by the order server to a first device via a computer network to thereby cause the first device to display the code on a display of the first device and allow a second device to scan the code, wherein the first device is one of a staff computing device and a first patron computing device at the restaurant, and the second device is another of the staff computing device and the first patron computing device, the second device being different than the first device;
receiving by the order server a received code from the second device via the computer network;
determining by the order server whether the received code matches the code uniquely identifying the order;
in response to determining that the received code matches the code, storing by the order server an association of the first patron computing device with the order in the one or more storage devices and add to the order one or more first food items as specified in one or more messages received from the first patron computing device via the computer network;
receiving by the order server a second received code from a second patron device via the computer network, wherein the second patron device determined the second received code as a result of interacting with the first patron computing device;
determining by the order server whether the second received code matches the code uniquely identifying the order; and
in response to determining that the second received code matches the code, storing by the order server an association of the second patron computing device with the order in the one or more storage devices and add to the order one or more second food items as specified in one or more messages received from the second patron computing device via the computer network;
whereby both the first patron computing device and the second patron computing device add one or more food items to the order.

20. The method of claim 19, further comprising:
storing a record of which of the food items of the order were ordered utilizing the first patron computing device and which of the food items of the order were ordered utilizing the second patron computing device;
sending a first billing screen to the first patron computing device, the first billing screen including all of the food items of the order selectable for payment where only the first food items ordered on the first patron computing device are preselected for payment; and
sending a second billing screen to the second patron computing device, the second billing screen including all of the food items of the order selectable for payment where only the second food items ordered on the second patron computing device are preselected for payment.
